(19) United States
(12) Patent Application Publication
(10) Pub. No.: US 2016/0107800 A1
(43) Pub. Date: Apr. 21, 2016

(54) ENCHANCED REDUCTION OF GARBAGE BAG CONTENTS

(71) Applicant: GARY STEINMAN, Jerusalem (IL)

(72) Inventor: GARY STEINMAN, Jerusalem (IL)

(21) Appl. No.: 14/519,151

(22) Filed: Oct. 21, 2014

(51) Int. Cl. B65D 33/16; B29C 65/48

(52) U.S. Cl. CPC B65D 33/165; B65D 33/1691; B29C 65/48; B29L 2031/712

(57) ABSTRACT

To aid in the spontaneous opening of closed garbage bags deposited in landfills, a biodegradable bag tie made from plant sources is described. The preparation of the tie material includes hydrolysis with an enzymatic aqueous solution to make the strip amenable to rapid digestion by microorganisms indigenous to landfill environments. The strips may then be tied by knotting around the open end of the polyethylene garbage bag or by joining the two ends of the strip with double-sided adhesive tape. In this way, the closed tie is digested soon after deposition of the bag in a landfill, thereby also exposing its contents to local aerobic bacteria and fungi.

### CROSS-REFERENCES TO RELATED APPLICATIONS

Application Ser. No.14/619,400 originally filed Feb. 11, 2015.

### STATEMENT REGARDING FEDERALLY SPONSORED RESEARCH OR DEVELOPMENT

Not applicable

### THE NAMES OF THE PARTIES TO A JOINT RESEARCH AGREEMENT

Since this invention is the product of a single inventor, no joint agreement was needed.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable

### STATEMENT REGARDING PRIOR DISCLOSURES BY THE INVENTOR OR A JOINT INVENTOR

The claimed invention was not patented, described in a printed publication, or in public use, on sale, or otherwise available to the public by the inventor before the effective filing date of the claimed invention.

### SEQUENCE LISTING

Not applicable

### BACKGROUND OF THE INVENTION

1. Field of the Invention

The present inexpensive invention concerns a pretreated tie device isolated from botanic sources for accelerating the exposure of the inner contents of sealed polyethylene rubbish bags to promote biodegradation by the native microflora within the natural environment of a common landfill, thereby augmenting the rate of decomposition of such deposited waste mass.

2. Description of Related Art

Much confusion in the scientific and governmental literature has resulted from the broad, indefinite meaning of the term “biodegradable.” Containers, such a rubbish bags, have been defined as biodegradable whether they are decomposed by fungi and bacteria completely to basic end-products such as carbon dioxide, water, and methane, or to mixtures containing small fragments of polyethylene along with these basic end-products. Such containers may initially be composed of polysaccharides or various combinations of degradable sugars and synthetic organic polymers. These formulations commonly result in more costly and less strong container bags.

Currently, garbage is commonly disposed of in polyethylene rubbish bags sealed with plastic ties which may take several hundred years to degrade by natural means because of the barrier of the degradable contents to landfill microflora created by the bag wall, thereby preventing timely reduction of the landfill mass. As will be noted below, the present bag tie invention involves a pretreated material from natural plant sources which is subject to greatly accelerated decomposition, thereby promoting bag opening and contact exposure of its contents in a common landfill microfloral environment.

US Patent Application 20140161375 of Betts et al. describes a bag for retaining useable items which employs a reusable tie, part of which is composed of a wire strip within the tie to retain the initial strength of the closure. Thus, the tie of Betts et al. is useful because of its resistance to breakage, thereby isolating the contents of the bag from the external factors. This is in contradistinction to the present invention which benefits from the rapid degradation of the tie, so as to make the contents of the container exposed early to the outside environment

### BRIEF SUMMARY OF THE INVENTION

Presently, municipal and commercial biodegradable garbage is typically discarded in sealed plastic bags. The present bag tie invention defines a simple, inexpensive, pretreated tie device made from natural plant components designed to expose the garbage contents of rubbish bags to the degradative microflora of a landfill environment more quickly following deposition.

Reducing decomposition time in this natural way would reduce overhead cost and “green house” gas production, and enhance renewable space for waste disposal in a landfill.

### BRIEF DESCRIPTION OF THE SEVERAL VIEWS OF THE DRAWINGS

Not applicable

### SPECIFICATION

This invention relates to a biodegradable refuse bag tie closure (where the bag itself may or may not also be biodegradable) made from natural biological plant materials. In particular, it relates to a means for allowing spontaneous opening of disposed refuse bags without human intervention, as promoted by indigenous landfill microorganisms. This would allow the more rapid degradation of waste contained within the bags due to the newly established exposure of the contents to degrading factors in the natural environment outside the trash bag in the deposition site, such as a landfill.

To aid in the separation of the bag tie, the material of which it is made is impregnated with a peroxide which is able to slow release its oxygen when moistened. An additional accelerant would the combination of the tie with a degradating enzyme such as cellulase during the manufacturing process, followed by dessication.

The need for more rapid degradation of rubbish is well known as an aid to improving the general environment of ecosystems populated by humans in particular. Currently, most home and industrial disposable waste is stored in polyethylene-type plastic bags. The time needed for unassisted biodegradation is typically measured in years and centuries, isolated from potentially decomposing factors by closed plastic bags, due to the oxygen-deficient conditions within such sealed containers. As a result, biodegrading microorganisms encounter insufficient oxygen to be active metabolically. Such microbes may have been present within the discarded materials or existed within the surrounding environment.

### DETAILED DESCRIPTION OF THE INVENTION

With rapidly expanding landfill sites and the threat of environmental contamination from overflow and seepage, ways to enhance the natural degradation of deposited refuse must be sought. Under present conditions in most places, deposits in landfills may last many years, if not decades and centuries. One of the culprits is the increasing use of sealed polyethylene bags to retain domestic and food service wastes until such time as they may be collected and deposited in local landfills or shipped to distant sites. The problem with this approach is that such bag polymers themselves degrade very slowly, so that the limiting size of the dump site is reached in relatively short periods of time and new locales must be found, thereby reducing nearby land available for habitation. If the contents of such bags are isolated by the plastic walls of the container from the ecological environment, including biodegrading bacteria and fungi, the rate of decomposition of the waste is markedly slowed. Such microorganisms could have been part of the initial bag contents or could have entered from the natural environment of the landfill once the refuse contents are exposed to the ecosystem.

Bags that are totally biodegradable, commonly made from modified carbohydrates, are available commercially. However, they suffer from several limitations, including high cost, small volume, weak sidewalls, and disposal limited to heavily controlled composite sites.

The present invention describes a means for producing and providing a tie device for exposing the inner contents of common polymeric rubbish bags to accelerated biodegradation within the natural environment, thereby enhancing the reduction of deposited biomass. If the contents are shielded from the environment for an extended period of time, slow aneraobic metabolic degradation, which produces organic acids and methane (a significant air pollutant), would be favored. The absence of a sufficient oxygen supply to the contents of the enclosed garbage, typically closed with a plastic strip tie, can essentially halt any ongoing aerobic biodegradation that may have been possible at the time of or soon after refuse deposit in the landfill. If the bag contents could be exposed to the ambient air and environmental organisms more quickly, aerobic metabolism would be favored, resulting in the production of water and carbon dioxide instead.

Typically, aerobic metabolism proceeds much faster than anerobic pathways. Therefore, it is proposed that this bag tie device to be described here offers a simple, inexpensive means for exposing the bag contents more quickly to the landfill environment of fungi and bacteria (soon after deposition) at low added cost and input of effort. Biological waste typically represents 45-60% of landfill deposits. While the polyethylene bag itself and any metallic/glass/plastic contents would remain, the majority of the biodegradable contents, especially food and yard trimmings, would expeditiously diminish in size as the enhanced breakdown process proceeded. The current use of recycling further enhances this advantage in expediting the removal of bio-wastes.

What is described in more detail here is a means for opening naturally the sealed refuse bag soon after deposition in a landfill. Whereas the bag itself can continue to be produced commercially from polythene or similar film in this model, the tie closing it tightly at its usual upper opening can be made from natural plant materials, especially those that are discarded because of otherwise inadequate usefulness for humans. Such botanics can be the object of in situ biodegradation as well. In analyzing the decaying contents of landfills, materials which are most subject to biodegradation include food stuffs and yard waste such as grass shavings, leaves, and bush trimmings. Contributing to the bioactivity via this device is the fact that the composition of naturally occurring botanical materials such as lettuce leaves and celery can include up to 94% water, a component needed to expedite the enzyme activities of the microorganisms.

More particularly, raw materials for use in the novel bag tie closure described in the present disclosure might include normally discarded fronds, husks, and leaves of such sources as corn, lemon grass, palm, cabbage, lettuce artichoke, aloe, and bamboo, among many possible botanic sources. For use in the here-described manner, the irregularly shaped starting material for the tie would be cut into more manageable strips.

To aid in the utility of the so-created strips, they would initially be subjected to limited hydrolysis and disruption of their underlying intertwined lignin/cellulose support structure using various combinations of aqueous acidic or basic chemical solutions, enzymes, and microwave devices. The step effecting hydrolysis using acid, base, or enzymes can be executed separately with heat or can be combined with the microwave step without thermal heating. After washing with water, the strips are sprayed with dilute aqueous solutions of oxygen-releasing inorganic peroxides. This component would act to supply oxygen locally once the tie-bearing bags would be placed in the landfill. The inorganic peroxides typically are stable at room temperature but break down to release oxygen in elevated temperature environments, such as being buried within a landfill.

An additional elective aid to accelerating metabolic degradation might be to mix sand with the covering soil, thereby enhancing its porosity to water and air.

The advantages of such an innovative bag tie would be:
1) Low cost
2) Ease of storage before use
3) Diminished accumulated size of active landfills
4) Greatly accelerated biodegradation
5) Reduced release of explosive, environmentally unfriendly methane
6) Simple use in a format commonly known to the consumer public (bag+tie closure)
7) No major change in bag production methods

The following is a typical example of the steps in preparing and using these biodegradable bag ties. It should be clear to anyone knowledgable in the art that variations of concentrations and strip dimensions as well as raw material sources could be employed to achieve similar results:

### Preferred Pretreatment and Application of the Tie Device

Corn husks are cut into strips 1 inch by 8 inches. The ties are submerged in a dilute aqueous solution of cellulase at 37° C. for 50 minutes. The strips are then washed by dipping in plain water until neutral, followed by spraying them lightly with 0.05% (w/v) magnesium peroxide aqueous solution until slightly moist. This is followed by air-drying at 25 degrees centigrade for 12 hours and then stored.

At the time of use, a tie strip is placed around a polyethylene garbage bag circumferentially near the open top and is tightened in place by a double knot made with the two ends of the tie strip or by double-sided tape of 2 inches in length applied to one end of the tie and pressed against the other end so that they adhere together.

What is claimed is:

1. A novel process for preparing special biodegradable bag ties comprising:
a) collecting natural plant products for said biodegradable refuse bag ties comprising fronds, husks, corn leaves, lemon grass leaves, palm leaves, cabbage leaves, rice leaves, coconut leaves, lettuce leaves, artichoke leaves, aloe leaves, cactus leaves, or bamboo leaves, and cutting them into strips 1-3 inches wide by 7-14 inches long to provide plant strips;
b) pretreating said plant strips by incubating them in a dilute aqueous solution comprising cellulase, cellobiohydrolase, endoglucanase, xylanase, pectinase, cellobiase, or hemicellulase at 37° C. for 5-50 minutes to provide pretreated plant strips;
c) impregnating said pretreated plant strips with inorganic peroxide by lightly spraying a 0.01-0.1% aqueous solution comprising one of strontium peroxide, calcium peroxide, magnesium peroxide, barium peroxide (with sodium chlorate), hydrogen peroxide (combined with an ester of pyrocarbonic acid or an N-vinyl heterocylic), lithium peroxide, sodium peroxide, sodium peroxyborate monohydrate, or sodium carbonate peroxyhydrate, and air-drying for 12 hours at 23-27° C.;
d) applying a 2-3 inch long strip of double-side adhesive tape to one end of said pretreated strips and retaining an inert tape backing.

2. (canceled)

3. (canceled)
